(19) United States
(12) Patent Application Publication
(10) Pub. No.: US 2026/0122019 A1
(43) Pub. Date: Apr. 30, 2026

(54) INTEGRATING TASK MANAGEMENT WITHIN MESSAGING APPLICATIONS

(71) Applicant: Malavika Mihir Patel, Lakewood, OH (US)

(72) Inventor: Malavika Mihir Patel, Lakewood, OH (US)

(21) Appl. No.: 18/929,856

(22) Filed: Oct. 29, 2024

(51) Int. Cl. H04L 51/21; G08B 21/24

(52) U.S. Cl. CPC H04L 51/21; G08B 21/24

(57) ABSTRACT

One or more systems, devices, computer program products and/or computer-implemented methods of use provided herein relate to integration of task management within messaging applications. For example, according to an embodiment, a system is provided. The system can comprise a memory that can store computer-executable components. The system can further comprise a processor that can execute the computer-executable components stored in the memory, where the computer-executable components can comprise a data access component that can access one or more messages generated within a messaging application, and one or more task generation instructions associated with the one or more messages. The computer-executable components can further comprise a task generation component that can generate, based on the one or more messages and the one or more task generation instructions, one or more tasks within the messaging application.

### BACKGROUND

The subject disclosure relates to task management software and, more specifically, to integration of task management within messaging applications.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable integration of task management within messaging applications are discussed.

According to an embodiment, a system is provided. The system can comprise a memory that can store computer-executable components. The system can further comprise a processor that can execute the computer-executable components stored in the memory, where the computer-executable components can comprise a data access component that can access one or more messages generated within a messaging application, and one or more task generation instructions associated with the one or more messages. The computer-executable components can further comprise a task generation component that can generate, based on the one or more messages and the one or more task generation instructions, one or more tasks within the messaging application.

According to another embodiment, a computer-implemented method is provided. The computer-implemented method can comprise accessing, by a system operatively coupled to a processor, one or more messages generated within a messaging application, and one or more task generation instructions associated with the one or more messages. The computer-implemented method can further comprise generating, by the system, based on the one or more messages and the one or more task generation instructions, one or more tasks within the messaging application.

According to yet another embodiment, a computer program product is provided. The computer program product can comprise a computer readable storage medium having program instructions embodied therewith, the program instructions executable by a processor to cause the processor to access, by the processor, one or more messages generated within a messaging application, and one or more task generation instructions associated with the one or more messages. The program instructions can be further executable by the processor to cause the processor to generate, by the processor, based on the one or more messages and the one or more task generation instructions, one or more tasks within the messaging application.

### BRIEF DESCRIPTION OF THE DRAWINGS

One or more embodiments are described below in the Detailed Description section with reference to the following drawings:

FIG. 1 illustrates a block diagram of an example, non-limiting system that can convert messages generated within a messaging application into tasks within the messaging application, in accordance with one or more embodiments described herein.

FIG. 2 illustrates another block diagram of an example, non-limiting system that can convert messages generated within a messaging application into tasks within the messaging application, in accordance with one or more embodiments described herein.

FIG. 3 illustrates a flow diagram of an example, non-limiting method that can convert a message generated within a messaging application into tasks and generate secondary data related to the tasks, in accordance with one or more embodiments described herein.

FIG. 4 illustrates a flow diagram of an example, non-limiting method that can convert a plurality of messages generated within a messaging application into respective tasks and generate secondary data related to the respective tasks, in accordance with one or more embodiments described herein.

FIG. 5 illustrates a flow diagram of an example, non-limiting method that can employ cloud-based computing to convert messages generated within a messaging application into tasks within the messaging application, in accordance with one or more embodiments described herein.

FIG. 6 illustrates a flow diagram of an example, non-limiting method that can generate an alert to an end user of a messaging application based on an example, non-limiting geographic location of the end user, in accordance with one or more embodiments described herein.

FIG. 7 illustrates a flow diagram of an example, non-limiting method that can convert messages generated within a messaging application into tasks within the messaging application and that can generate alerts based on the tasks, in accordance with one or more embodiments described herein.

FIG. 8 illustrates a flow diagram of an example, non-limiting method that can convert messages generated within a messaging application into tasks within the messaging application, in accordance with one or more embodiments described herein.

FIG. 9 illustrates a block diagram of an example, non-limiting operating environment in which one or more embodiments described herein can be facilitated.

FIG. 10 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Messaging applications such as WhatsApp® and iMessage® are often inadvertently employed for task management. For example, a first end user of a messaging application can send a text message via the messaging application requesting a second end user of the messaging application to email the first end user a document. Text messages in messaging applications are often associated with messaging indicators such as delivery receipts, read receipts or similar indicia that can indicate that the text messages have been delivered to and/or read by the intended recipients. However, existing messaging indicators do not communicate that a task referenced in a text message has been completed. For example, existing messaging applications that are primarily employed for chats/conversations do not comprise functionalities where end users can explicitly communicate to one another that a task has been completed, and where end users can be reminded about pending tasks in case forgetfulness creeps in. For example, both the first end user and the second end user can become occupied with other matters, as a result of which, the document does not get emailed by the second end user to the first end user on time. Some existing solutions include applications that are specifically designed for task management and collaboration. However, task management applications are often designed for end goals involving multiple tasks such as, for example, project management, and such applications often do not cater to everyday scenarios involving conversations on existing messaging applications. Additionally, many end users can find it inconvenient to switch between applications (e.g., from a messaging application to a collaboration-based application) based on whether a conversation involves a task. Thus, solutions that can provide more task messaging functionalities within existing messaging applications can be desirable.

Various embodiments of the present disclosure can be implemented to produce a solution to these problems. Embodiments described herein include systems, computer-implemented methods, and computer program products that can integrate task management functionalities within messaging applications. For example, in various embodiment, a task generation model is provided that can access a message generated as part of a chat/conversation within a messaging application and generate, based on the information comprised in the message, one or more tasks within the messaging application. For example, the task generation model can access the message and task generation instructions provided by an end entity (e.g., hardware, software, machine, AI, neural network and/or user), wherein the end entity can be the sender or the recipient of the message, and wherein the task generation instructions can comprise instructions to generate a task based on the message. In one or more embodiments, the task generation model can employ a large language model (LLM) that can generate, based on the message and the task generation instructions, a prompt. In one or more embodiments, the task generation model can further employ an artificial intelligence (AI) model that can convert, based on the prompt, the message into a task within the messaging application. In one or more embodiments, the AI model can generate secondary data based on the task and secondary instructions provided by the end entity, wherein the secondary data can comprise information that can assist the end entity with completing one or more actions corresponding to the task. In one or more embodiments, the task management model can also generate an alert to the end entity based on the task, wherein the alert can comprise a reminder or another type of alert related to the task to further assist the end entity with completing the one or more actions corresponding to the task. In one or more embodiments, the task management model can be employed in an automatic mode, wherein the task management model can automatically generate, based on the message and without inputs from the end entity, the one or more tasks and the secondary data. In one or more embodiments, the task management model can periodically train the AI model based on tasks previously generated by the AI model to enhance the accuracy of task generation by the AI model.

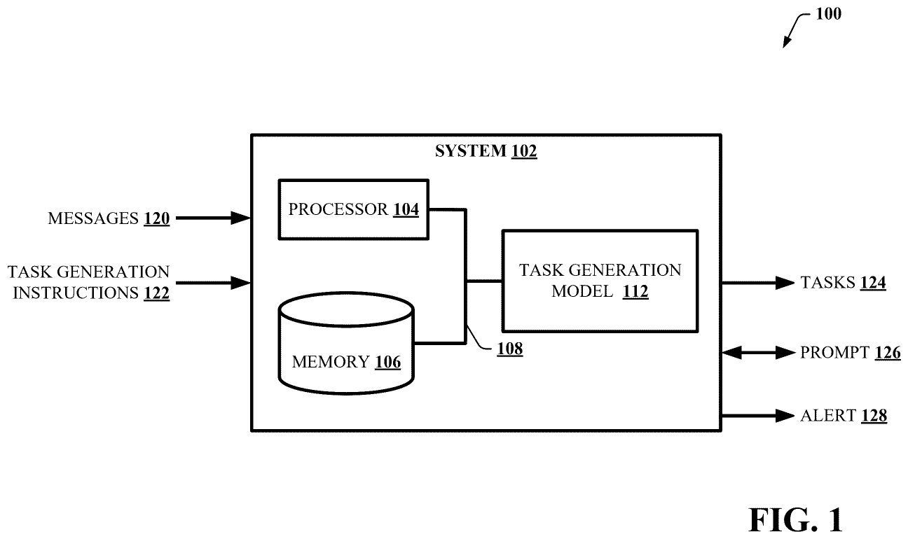

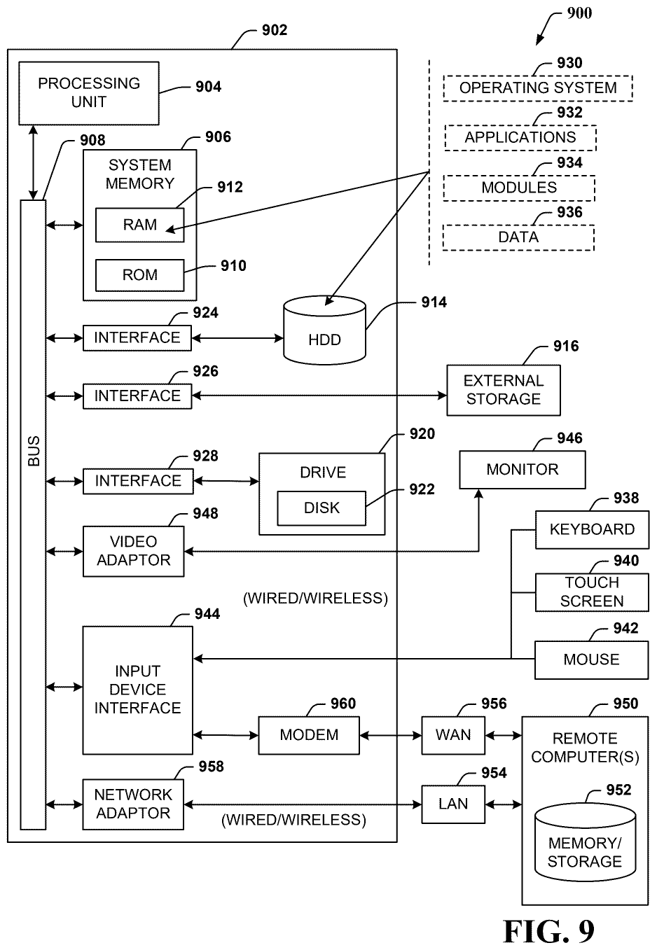

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 900 illustrated at FIG. 9. For example, non-limiting system 100 can be associated with, such as accessible via, a computing environment 900 described below with reference to FIG. 9, such that aspects of processing can be distributed between non-limiting system 100 and the computing environment 900. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can convert messages generated within a messaging application into tasks within the messaging application, in accordance with one or more embodiments described herein.

Non-limiting system 100 and/or the components of non-limiting system 100 can be employed to use hardware and/or software to solve problems that are highly technical in nature (e.g., related to messaging software, task generation, AI-based functionalities in messaging applications, etc.), that are not abstract and that cannot be performed as a set of mental acts by a human. Further, some of the processes performed may be performed by specialized computers for carrying out defined tasks related to integration of task management within messaging applications. Non-limiting system 100 and/or components of non-limiting system 100 can be employed to solve new problems that arise through advancements in technologies mentioned above and/or the like. Non-limiting system 100 can provide improvements to communication systems by enhancing the functionalities of communication system such as messaging applications and platforms by enabling the conversion of messages to actionable tasks with checkboxes. In one or more embodiments, such functionalities can be provided via AI models and/or machine learning algorithms as well as cloud-based quantum computing to efficiently process data from end entities and generate personalized outcomes. As a result, existing messaging applications and platforms can also be employed to efficiently manage everyday tasks. The various embodiments of the present disclosure can also reduce the time spent by entities (e.g., hardware, software, machine, AI, neural network and/or users) in completing such tasks.

In one or more embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., data access component 202, prompt generation component 204, task generation component 206, task storage component 208, alert component 210 and/or training component 212) to perform one or more actions. In one or more embodiments, memory 106 can store computer-executable components (e.g., data access component 202, prompt generation component 204, task generation component 206, task storage component 208, alert component 210 and/or training component 212).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

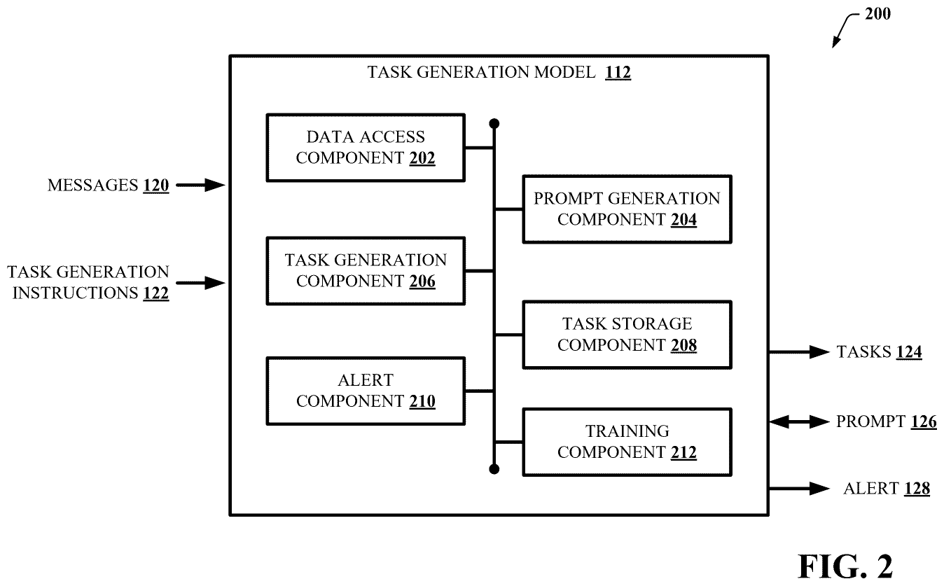

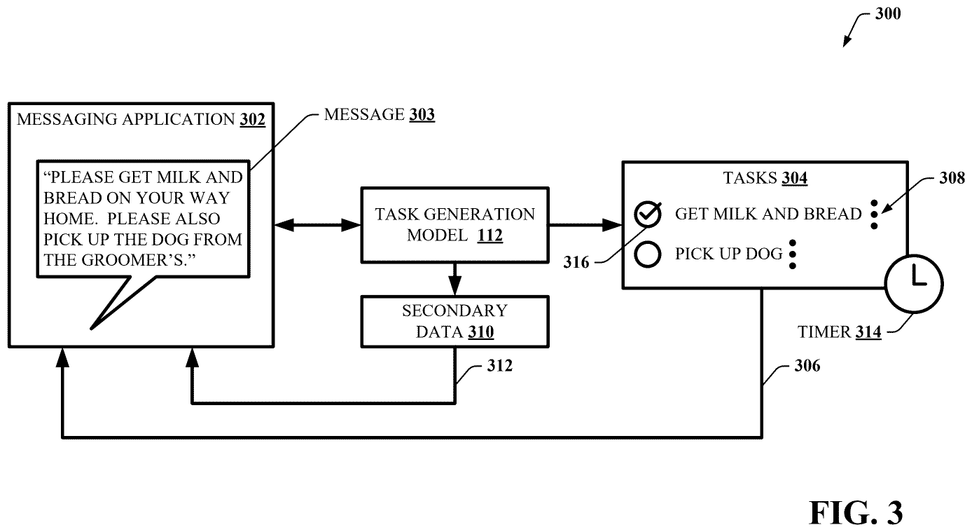

In one or more embodiments, system 102 can comprise task generation model 112. In one or more embodiments, task generation model 112 can comprise data access component 202, prompt generation component 204, task generation component 206, task storage component 208, alert component 210 and training component 212, as illustrated in FIG. 2. In various embodiments, task generation model 112 can be an AI-based model or an AI model that can convert one or more messages generated within a messaging application (e.g., messaging application 302 of FIG. 3) into one or more tasks. For example, task generation model 112 can be connected (e.g., communicatively, programmatically, logically and/or via like function) to the messaging application, such that task generation model 112 can access conversational data generated by end entities (e.g., hardware, software, machine, AI, neural network, and/or user) within the messaging application and convert one or more messages comprising the conversational data into one or more tasks. For example, the conversational data can be a text message conversation wherein a lady has messaged her husband to pick-up their children from school and buy groceries on the way. In one or more embodiments, task generation model 112 can convert the text message into two tasks, wherein the first task can comprise picking up the children from school (e.g., “Pick up kids from school”) and the second task can comprise buying groceries (e.g., “Buy groceries”). In one or more embodiments, task generation model 112 can present the two tasks as a task list within the messaging application, wherein the task list can be generated in place of the text message or as message immediately following the text message.

In one or more embodiments, the messaging application can be an existing internet-based messaging application. For example, the messaging application can be an instant messaging (IM) application, an Over-The-Top (OTT) messaging application or another Rich Communication Services (RCS)-based messaging application that can be employed by an end entity (e.g., hardware, software, machine, AI, neural network and/or user) to communicate with one or more other end entities (e.g., hardware, software, machines, AI, neural networks and/or users).

More specifically, in various embodiments, data access component 202 can access one or more messages (i.e., messages 120) generated within a messaging application (i.e., messaging application 302 of FIGS. 3-6) and one or more task generation instructions (i.e., task generation instructions 122) associated with the one or more messages. In various embodiments, messages 120 can comprise one or more messages generated by one or more end entities (e.g., hardware, software, machines, AI, neural networks and/or users) as text messages, voice messages, picture messages and/or messages having any other format. For example, in an embodiment, messages 120 can comprise a voice message sent by a first individual to a second individual, from the first individual's smartphone to the second individual's smartphone, as a chat/conversation via the messaging application. In another embodiment, messages 120 can comprise one or more text messages sent by one or more individuals in a group chat within the messaging application. Further, messages 120 can comprise actionable items. For example, the voice message from the first individual can be a message requesting the second individual to buy specific grocery items. Similarly, in the group chat scenario, one individual can send a plurality of text messages indicating what each of the other individuals should prepare for a potluck dinner.

In various embodiments, task generation instructions 122 can comprise at least one type of instructions selected from a group consisting of verbal instructions and non-verbal instructions. In various embodiments, task generation instructions 122 can comprise instructions to generate one or more tasks (i.e., tasks 124) based on messages 120. For example, consider the scenario wherein the first individual sends a voice message to the second individual as a chat within the messaging application. Upon receiving the voice message, the second individual can press and hold the screen of their smartphone to select, via a touch screen functionality of the smartphone, the voice message from the first individual. The selection thus made by the second individual can reveal a list of options comprising the option to convert the voice message into tasks 124 (e.g., convert to tasks), and the second individual can manually select the option to convert the voice message into tasks 124 via the touch screen functionality of the smartphone. Alternatively, the second individual can provide verbal instructions to an AI chat assistant, via the microphone of the smartphone, to convert the voice message to tasks 124, without manually selecting the voice message. Thus, task generation instructions 122 can comprise any suitable form of verbal or non-verbal instructions now known or to be developed in the future. In some embodiments, task generation instructions 122 can be provided by the click of a single option on the user interface (UI) of a device (e.g., a smartphone, a smartwatch, a tablet, etc.) being employed to engage with the messaging application.

In various embodiments, task generation component 206 can generate, based on messages 120 and task generation instructions 122, tasks 124 within the messaging application. For example, in various embodiments, data access component 202 can input messages 120 and task generation instructions 122 to prompt generation component 204. In various embodiments, prompt generation component 204 can be an LLM that can generate prompt 126 based on messages 120 and task generation instructions 122. Prompt generation component 204 can be any suitable LLM now known or to be developed in the future. In various embodiments, prompt 126 can comprise an input context such as a command or question based on information from messages 120 and task generation instructions 122, wherein the input context can define the main instructions for guiding outputs generated by downstream models such as task generation component 206. Additionally, the input context can have a format suitable as an input format (e.g., natural language, code, comma-separated values (CSV), etc.) for specific downstream models. Prompt 126 can further comprise a desired output format (e.g., a list, paragraph, etc.) for outputs generated by the downstream models. For example, prompt 126 can be a command such as “Generate a list of tasks with checkboxes for each task based on the following text . . . ”

In various embodiments, task generation component 206 can access prompt 126, and based on prompt 126, task generation component 206 can convert messages 120 into tasks 124 within the messaging application. For example, in one or more embodiments, task generation component 206 can be an AI model such as a natural language processing (NLP) model that can generate tasks 124 based on prompt 126. For example, task generation component 206 can be a transformer-based language model or a generative pre-trained model such as a Bidirectional Encoder Representations from Transformers (BERT) model, a Robustly Optimized BERT Pretraining Approach (ROBERTa) model, etc. Task generation component 206 can also be a Named Entity Recognition (NER) model, a reinforcement learning model, a Text-to-Text Transfer Transformer (T5) model, a task-specific AI model, and so on. For example, task generation component 206 can be a T5 model that can access data from task generation instructions 122 and messages 120 comprised in prompt 126 and generate a structured list of tasks (i.e., tasks 124) via text summarization or text extraction of the text data from messages 120. In one or more embodiments, task generation component 206 can comprise one or more of a BERT model, a ROBERTa model, an NER model, a reinforcement learning model, a T5 model, a task-specific AI model, etc. In one or more embodiments, task generation component 206 can comprise models (e.g., AI models, machine learning models, etc.) that can interact with one or more other models to generate tasks 124 based on messages 120. In some embodiments, task generation component 206 can also be a suitable rule-based software.

In various embodiments, respective tasks of tasks 124 can correspond to respective actions that are executable by an end user of the messaging application. Further, the respective tasks can be generated with respective checkboxes, by task generation component 206, within the messaging application, wherein the checkboxes can be employable by the end user to indicate respective completion statuses of the respective actions. For example, with continued reference to the exemplary scenario wherein the first individual sends a voice message to the second individual, via the messaging application, requesting the second individual to buy specific grocery items, tasks 124 can appear as a to-do item with a checkbox within the chat. The checkbox can be selected (e.g., via the touchscreen functionality of the smartphone, verbal instructions to the AI chat assistant, etc.) by the second individual once the specific grocery items have been purchased. Further, upon realizing the some of the groceries items have not been purchased, the second individual can unselect the checkbox. If the voice message also comprises a request from the first individual to the second individual to mail a letter at the post office in addition to purchasing the grocery items, task generation component 206 can generate a second to-do item with a corresponding checkbox that can be selected/unselected by the second individual as desired. Thus, tasks 124 can comprise one or more tasks generated by task generation component 206, wherein the one or more tasks can be generated as individual tasks or as a task list within a chat in the messaging application. In some embodiments, tasks 124 can replace messages 120 within a chat, whereas in other embodiments, tasks 124 can appear as one or more separate messages within the chat. In one or more embodiments, tasks 124 can also appear as separate chats within the messaging application.

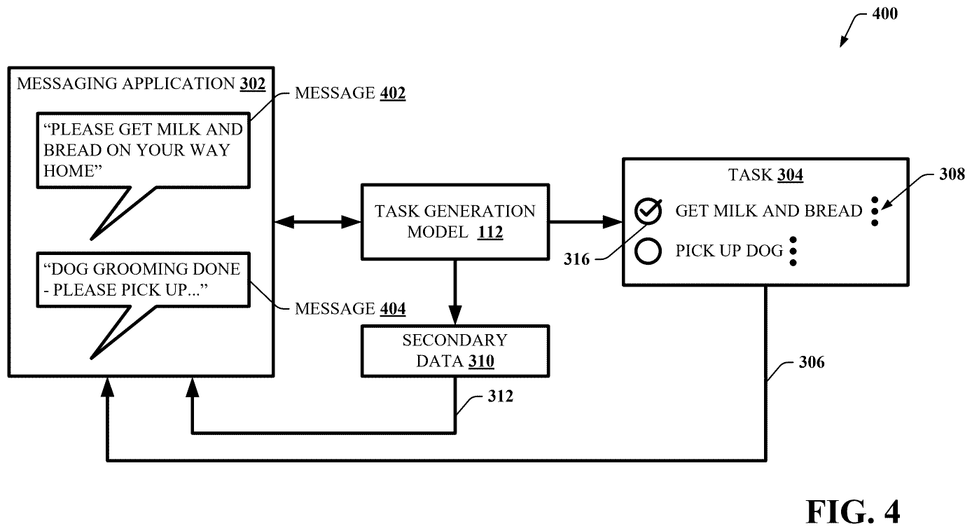

In an embodiment, a checkbox corresponding to a task comprised in tasks 124 can appear as selected only when all entities (e.g., hardware, software, machines, AI, neural network and/or users) responsible for completing the task have selected the checkbox. For example, an entity can send a message (e.g., “Please confirm when you reach the dinner venue”) to multiple other entities in a group chat in the messaging application. Task generation model 112 can convert the message into a task (e.g., “Send arrival confirmation for dinner”) with a checkbox within the group chat, and once all the recipients of the message have selected the checkbox as a confirmation of their respective arrivals, the checkbox can appear as selected (e.g., as illustrated at 316 in FIGS. 3 and 4).

In various embodiments, task generation component 206 can further generate secondary data (e.g., secondary data 310 of FIGS. 3 and 4) to assist the end user of the messaging application to execute the respective actions. For example, upon generation of tasks 124 within the chat, the second individual can provide secondary instructions (e.g., via the touchscreen functionality of the smartphone, verbal instructions to the AI chat assistant, etc.) to request additional information that can assist the second individual to perform actions corresponding to tasks 124. For example, the secondary instructions can comprise requests for addresses of grocery stores and post offices within a defined distance from the second individual. The secondary instructions can be accessed by data access component 202 and compiled into a prompt by prompt generation component 204, based on which, task generation component 206 can generate secondary data comprising the addresses of grocery stores and post offices within the defined distance from the second individual. In this scenario, secondary data can comprise geographic location information associated with the respective actions. In other scenarios, secondary data can comprise any relevant information requested by one or more entities (e.g., hardware, software, machines, AI, neural network and/or user) engaging in a chat/conversation in a messaging application to assist the one or more entities to execute actions corresponding to tasks 124. To generate the secondary data, task generation component 206 can access various sources of information such as online databases, global positioning system (GPS) data, websites, etc.

In various embodiments, alert component 210 can generate, based on the secondary data, alert 128 to an end entity (e.g., hardware, software, machine, AI, neural network and/or user) employing the messaging application. For example, alert 128 can inform/notify the second individual that the second individual is within a geographic zone or within a defined geographic distance from a grocery store. In general, alert 128 can notify the end entity that the end entity is within a geographic zone associated with respective actions corresponding to tasks 124. In various embodiments, alert 128 can comprise any suitable type of alert related to tasks 124. For example, if tasks 124 comprise a task to mail letters, alert 128 can be an alert notifying the second individual about operating hours of different post offices near the second individual. Alert 128 can also alert the second individual that a post office nearest to the second individual is about to close for the business day. In one or more embodiments, alert 128 can alert multiple entities (e.g., hardware, software, machines, AI, neural networks and/or users). For example, alert 128 can alert the first individual when the second individual is within a defined distance from the grocery store, such that the first individual can add additional items to the initial grocery list indicated by the first individual in the voice message. Thus, alert 128 can comprise any suitable alert based on tasks 124 and the related secondary data, and alert component 210 can generate alert 128 to one or more end entities participating in a chat in the messaging application.

In one or more embodiments, task generation model 112 can automatically generate tasks 124 based on messages 120 without inputs from an end entity (e.g., hardware, software, machine, AI, neural network and/or user) employing the messaging application and participating in a chat/conversation. Similarly, task generation model 112 can automatically generate secondary data based on tasks 124. For example, task generation model 112 can be employed in an automatic mode such that upon the second individual receiving the voice message from the first individual, tasks 124 can be automatically generated by task generation component 206, in accordance with one or more embodiments, without the second individual providing task generation instructions 122. For example, data access component 202 can access messages 120 in response to messages 120 being generated within a chat, and prompt generation component 204 can detect that messages 120 comprise information that can be converted to tasks 124. Accordingly, prompt generation component 204 can generate prompt 126, and task generation component 206 can generate tasks 124 based on prompt 126.

In general, task generation model 112 can perform task generation and task segmentation by employing one or more suitable models to interpret information comprised in messages 120. The automatic mode of task generation model 112 can be activated or deactivated by the end entity. In an embodiment, the end entity can employ the automatic mode of task generation model 112 to generate a to-do list for the end entity itself, that is, to self-track tasks. For example, the end entity can generate a message to themselves in a chat in the messaging application, and the task generation model 112 can generate tasks 124 based on the message within the chat.

In one or more embodiments, task storage component 208 can store tasks 124 as stored tasks in a storage (e.g., memory 106 or another type of storage). In an embodiment, task storage component 208 can store tasks 124 in the storage in a continuous manner, for example, upon generation of each new task by task generation component 206. In another embodiment, task storage component 208 can store tasks 124 in the storage in a periodic manner, for example, every ten days, every month, and so on. In one or more embodiments, training component 212 can employ the stored tasks to periodically train (e.g., retrain or fine-tune) task generation component 206. For example, training component 212 can employ the stored tasks to generate a training dataset, wherein the training dataset can be periodically updated as new tasks get stored in the storage by task storage component 208. Training component 212 can employ the training dataset to train task generation component 206 to generate new tasks with increased accuracy, for example, with accuracy greater than a defined threshold. For example, during training, task generation component 206 can minimize its loss function thereby reducing a difference between a desired quality of tasks and a quality of tasks generated by task generation component 206. As a result, the parameters such as the weights of task generation component 206 can be updated, and task generation component 206 can be trained to generated tasks more accurately.

In some embodiments, the training can be local to a device on which the messaging application is installed, whereas in other embodiments, the training can be cloud-based. In either case, data privacy of end entities employing the messaging application can be preserved. For example, local training can ensure that data that is private to an end user of the messaging application remains local to the device (e.g., a smartphone, a tablet, etc.) employed by the end user for the messaging application. Cloud-based training can be performed via techniques such as federated learning. In federated learning, task generation component 206 can be trained locally (e.g., at a device such as a smartphone, a tablet, etc.) by training component 212, and training component 212 can deploy only the updated parameters (e.g., weights and gradients) resulting from the training to a central server provided via a cloud environment. The central server can similarly access updated parameters (e.g., weights and gradients) of other task generation components identical to task generation component 206 and deployed within respective devices local to respective entities (e.g., hardware, software, machines, AI, neural networks and/or users). At the central server, a software can train a global model based on aggregated weights and gradients from the different task generation components, and the trained global model can be redeployed by the central server to each device as a local task generation component. For example, the global model can be deployed as task generation component 206. Thus, task generation component 206 can be trained via cloud-based training without sensitive data exiting a device, which can ensure that the training is secure.

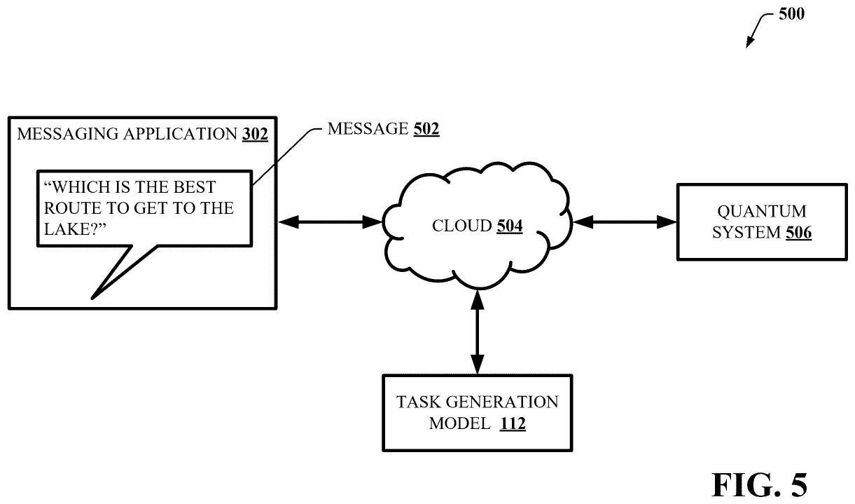

In an embodiment, task generation model 112 can be provided as an application that can be downloaded by an end entity (e.g., hardware, software, machine, AI, neural network and/or user) employing the messaging application to a device (e.g., a smartphone, a tablet, a laptop computer, a desktop computer, etc.) comprising the messaging application. In another embodiment, task generation model 112 can be provided as a cloud-based service, wherein data access component 202 can access messages 120 and task generation instructions 122 via cloud-based communication with a device hosting the messaging application. In one or more embodiments, tasks 124 can be generated via cloud-based quantum computing. The cloud-based embodiments of task generation model 112 are described in greater detail with reference to FIG. 5.

FIG. 2 illustrates another block diagram of an example, non-limiting system 200 that can convert messages generated within a messaging application into tasks within the messaging application, in accordance with one or more embodiments described herein. Repetitive description of like elements and/or processes employed in respective embodiments is omitted for sake of brevity.

Non-limiting system 200 illustrates the system of task generation model 112 of FIG. 1. As discussed with reference to FIG. 1, task generation model 112 can comprise data access component 202, prompt generation component 204, task generation component 206, task storage component 208, alert component 210 and training component 212.

In one or more embodiments, task generation model 112 can interact with an existing messaging application (e.g., messaging application 302 of FIG. 3) via application programming interfaces (APIs), software development kits (SDKs), intents, application extensions, deep linking, or other suitable techniques now known or to be developed in the future. APIs act as endpoints that allow applications to interact with one another. Some applications also offer SDKs that are libraries or tools that can be integrated into another application to allow the two applications to communicate. An application can also employ an intent to request another application to perform specific actions, wherein an intent refers to a mechanism that can be employed by an application to express a desire to communicate with another application. Application extensions are software components that allow additional features or functionalities such as external services to be integrated into an application.

In various embodiments, task generation model 112 can interact with the messaging application in accordance with legal and technical considerations surrounding the messaging application to provide the task generation functionalities discussed herein. For example, task generation model 112 can interact with the messaging application while accounting for the pertinent terms of service (ToS) and API policies associated with the messaging application, end-user privacy and data protection laws associated with the messaging application, and other relevant legal and security-related guidelines surrounding the messaging application. In one or more embodiments, task generation model 112 can interact with multiple existing messaging applications (e.g., messaging application similar to messaging application 302 of FIG. 3) to provide the task generation functionalities discussed herein, in accordance with the various embodiments of the present disclosure.

FIG. 3 illustrates a flow diagram of an example, non-limiting method 300 that can convert a message generated within a messaging application into tasks and generate secondary data related to the tasks, in accordance with one or more embodiments described herein. Repetitive description of like elements and/or processes employed in respective embodiments is omitted for sake of brevity.

Non-limiting method 300 illustrates an exemplary scenario wherein task generation model 112 can interact (e.g., communicatively, programmatically, logically and/or via like function) with messaging application 302 to convert one or more messages generated within messaging application 302 into one or more tasks. As stated elsewhere herein, messaging application can be an IM application, an OTT messaging application or another RCS-based messaging application, and a first end entity (e.g., hardware, software, machine, AI, neural network and/or user) can employ messaging application 302 to send message 303 (e.g., “Please get milk and bread on your way. Please also pick up the dog from the groomer's.”) to a second end entity (e.g., hardware, software, machine, AI, neural network and/or user) in a chat in messaging application 302. Further, message 303 can be sent from the first entity's smartphone (or another suitable device) to the second entity's smartphone (or another suitable device).

In an embodiment, upon receiving message 303, the second entity can generate task generation instructions (e.g., task generation instructions 122) that can be accessed by data access component 202 of task generation model 112, wherein the task generation instructions can comprise instructions to convert message 303 into one or more tasks (e.g., tasks 304). In another embodiment, task generation model 112 can be employed in automatic mode, and data access component 202 can automatically access message 303, for example, in response to message 303 being received by the second entity. Thereafter, prompt generation component 204 can generate a prompt (e.g., prompt 126) based on message 303 and the task generation instructions or based only on message 303 (e.g., if task generation model 112 is employed in automatic mode). Based on the prompt, task generation component 206 can generate, at 306, tasks 304, wherein the individual tasks (e.g., “Get milk and bread” and “Pick up dog”) can be accompanied by checkboxes. In an embodiment, tasks 304 can be generated in place of message 303. For example, task generation component 206 can convert message 303 into tasks 304 such that both the first entity and the second entity can view message 303 as being converted to tasks 304 within the chat. In another embodiment, tasks 304 can be presented as a separate message following message 303 and can be viewed by both the first entity and the second entity within the chat.

Upon completing an action corresponding to a task comprised in tasks 304, the second entity can select the related checkbox. For example, the second entity can purchase milk and bread from a grocery store and select the checkbox, as illustrated at 316, for the “Get milk and bread” task to mark the task complete. This functionality can assist the second entity to separate completed tasks from pending tasks and also assist the first entity to keep track of tasks 304.

In one or more embodiments, the second entity can select an options icon, such as illustrated at 308, to request secondary data 310, wherein secondary data 310 can comprise additional information that can assist the second entity to complete one or more tasks comprised in tasks 304. For example, the second entity can select the options icon generated by task generation component 206 within tasks 304 to provide secondary instructions requesting addresses or operating hours of grocery stores and post offices within a defined distance of the second entity. In response, task generation component 206 can generate, at 312, secondary data 310. In embodiments wherein task generation model 112 is employed in automatic mode, task generation component 206 can generate secondary data 310 alongside tasks 304, without the secondary instructions being provided by the second entity. In one or more embodiments, secondary data 310 can be presented to the second entity in the chat with the first entity within messaging application 302 or as a separate message within messaging application 302.

In one or more embodiments, as second entity arrives within a geographic zone or a defined geographic distance of a grocery store and/or a post office, alert component 210 can generate an alert (e.g., alert 128), based on tasks 304, to the second entity notifying the second entity about the proximity of the grocery store. The alert can also notify the second entity about pending tasks comprised in tasks 304. In general, the alert can comprise one or more notifications to ensure that the second entity remains on track to complete tasks 304. In one or more embodiments, the second entity can set timer 314 via the options icon illustrated at 308, wherein timer 314 can delay the generation of alerts by alert component 210. For example, message 303 can be sent by the first entity to the second entity in the morning hours, but the second entity can decide to begin completing tasks 304 in the evening hours. Thus, the second entity can employ the options icon and set timer 314 (e.g., “Remind me in 2 hours”) that can control the timing of alerts generated by alert component 210.

FIG. 4 illustrates a flow diagram of an example, non-limiting method 400 that can convert a plurality of messages generated within a messaging application into respective tasks and generate secondary data related to the respective tasks, in accordance with one or more embodiments described herein. Repetitive description of like elements and/or processes employed in respective embodiments is omitted for sake of brevity.

With continued reference to FIG. 3, non-limiting method 400 illustrates additional embodiments of task generation model 112. In one or more embodiments, message 402 (e.g., “Please get milk and bread on your way home”) can be sent by the first entity to the second entity, and the second entity can additionally receive message 404 (e.g., “Dog grooming done-please pick up . . . ”) from the first entity or from a third entity (e.g., the dog groomer). In this scenario, message 402 and message 404 can be received by the second entity within a single chat (e.g., when received from the first entity) or within two separate chats (e.g., when received from the first entity and the second entity).

In either scenario, task generation model 112 can interact with messaging application 302 as described in one or more embodiments to generate tasks 304 (e.g., via task generation component 206). For example, task generation model 112 can generate tasks 304 (e.g., automatically or based on task generation instructions from the second entity) as a separate chat within messaging application 302 by detecting message 402 and message 404 as tasks. Additionally, or alternatively, task generation model 112 can generate tasks 304 within the relevant chats. For example, if messages 402 and 404 are individual messages sent by the first entity to the second entity, task generation model 112 can generate tasks 304 within the chat with the first entity. On the contrary, if message 402 is sent by the first entity and message 404 is sent by the third entity, task generation model 112 can generate tasks 304 as a separate chat within messaging application 302, generate the first task from tasks 304 (e.g., “Get milk and bread”) within the chat with the first entity and generate the second task from tasks 304 (e.g., “Pick up dog”) within the chat with the third entity to assist all the relevant end entities with tracking the completion of tasks 304. In one or more embodiments, message 402 and message 404 can be sent by the first entity and the third entity, respectively, to the second entity within the same chat (e.g., a group chat) in messaging application 302, and task generation model 112 can generate tasks 304 based on messages 402 and 404. As discussed in one or more embodiments, task generation model 112 can convert respective messages into respective tasks.

FIG. 5 illustrates a flow diagram of an example, non-limiting method 500 that can employ cloud-based computing to convert messages generated within a messaging application into tasks within the messaging application, in accordance with one or more embodiments described herein. Repetitive description of like elements and/or processes employed in respective embodiments is omitted for sake of brevity.

As discussed with reference to FIG. 1, in one or more embodiments, task generation model 112 can be provided as a cloud-based service. For example, task generation model 112 can be provided via cloud 504, wherein cloud 504 can be a cloud environment or a cloud-based server. Accordingly, task generation model 112 can interact with messaging application 302 via cloud-based communication to execute various operations to provide the task generation functionalities described in one or more embodiments of the present disclosure.

In one or more embodiments, cloud 504 can be connected (e.g., communicatively) to quantum system 506. For example, cloud 504 can be a cloud-based server that can be connected to quantum system 506 via cloud-based communication. Quantum system 506 can be a quantum computer comprising a quantum processor that can employ qubits to perform quantum computations. Quantum computers can perform large-scale computations more efficiently than classical computers and can be employed to solve problems related to complex simulations, cryptography, optimization, etc. In scenarios with many possible paths or solutions such as, for example, routes from one geographic location to another, quantum computers can be employed to efficiently compute the optimal routes.

Accordingly, in one or more embodiments, task generation model 112 can employ quantum system 506 to generate certain tasks, based on messages, via cloud 504. For example, message 502 (e.g., “Which is the best route to get to the lake?”) can be generated by a first entity (e.g., hardware, software, machine, AI, neural network and/or user) within messaging application 302 and received by a second entity. In an embodiment, the second entity can employ the functionalities of task generation model 112 integrated within messaging application 302 to convert message 502 into a task (e.g., “Identify best route to the lake for the second entity”). For example, upon receipt of message 502, the second entity can provide task generation instructions within messaging application 302, and the task generation instructions can be processed by task generation model 112 along with message 502 to convert message 502 into the task.

Thereafter, the second entity can provide secondary instructions comprising instructions to identify the best routes from the first entity to the lake, and the secondary instructions can also comprise information about the geographic location of the first entity and the location of the lake. Based on the secondary instructions, task generation model 112 can generate secondary data (e.g., secondary data 310 of FIG. 3) identifying the best route or routes from the geographic location of the first entity to the lake. To generate the one or more best routes, task generation model 112 can employ quantum system 506. For example, task generation model 112 can employ task generation component 206 to input data from the secondary instructions as an optimization problem to quantum system 506, via cloud-based communication. Quantum system 506 can evaluate, based on the secondary instructions, the different routes that the first entity can take from their geographic location to the lake, the amount of traffic that the first entity can expect to encounter on each route, and other relevant information, to generate the secondary data. Quantum system 506 can output a list of best routes to task generation model 112, and task generation model 112 can present the list of best routes as secondary data to the second entity and the first entity within messaging application 302.

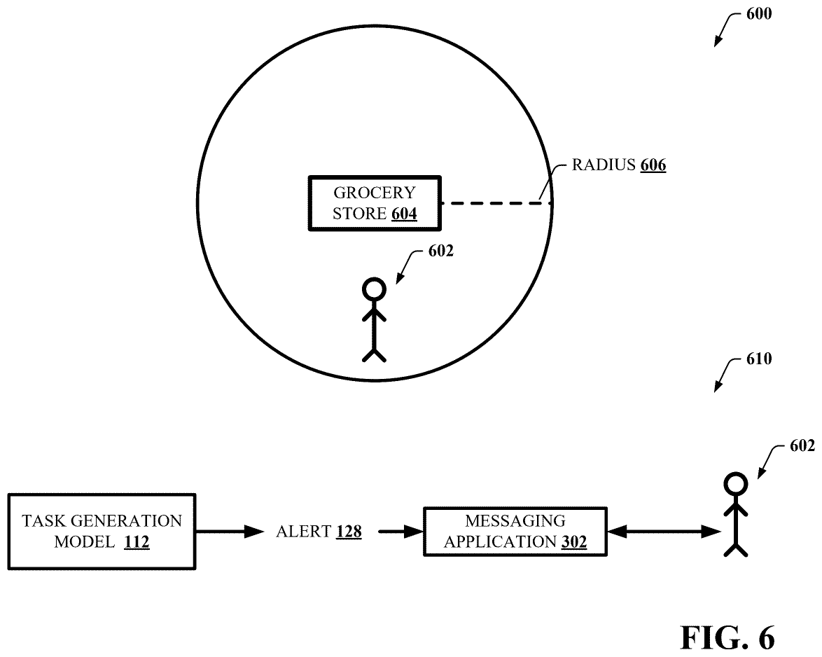

FIG. 6 illustrates a flow diagram of an example, non-limiting method 610 that can generate an alert to an end user of a messaging application based on an example, non-limiting geographic location 600 of the end user, in accordance with one or more embodiments described herein. Repetitive description of like elements and/or processes employed in respective embodiments is omitted for sake of brevity.

As discussed with reference to FIG. 1, alert component 210 can generate, based on secondary data (e.g., secondary data 310 of FIG. 3), alert 128 to an end entity (e.g., hardware, software, machine, AI, neural network and/or user) employing the messaging application (e.g., messaging application 302 of FIG. 3). In this regard, FIG. 6 illustrates one or more embodiments of alert component 210 in an exemplary scenario. For example, consider the scenario wherein a voice message can be sent by a first individual to a second individual, from the first individual's smartphone to the second individual's smartphone, as part of a chat/conversation in the messaging application, and wherein the voice message can comprise a request to the second individual to purchase specific grocery items (e.g., fruits, vegetables, etc.). In FIG. 6, the second individual is illustrated as person 602.

In one or more embodiments, task generation model 112 can convert the voice message to a task (e.g., “Buy groceries”) within the chat, and as person 602 approaches a grocery store (as illustrated by non-limiting geographic location 600 of person 602), alert component 210 of task generation model 112 can generate alert 128 to the second individual based on the task. For example, as illustrated by non-limiting method 610, as person 602 arrives within a defined distance (i.e., radius 606) of grocery store 604, alert component 210 can generate alert 128 notifying person 602 that grocery store 604 is in the vicinity of person 602. Radius 606 can be any defined distance (e.g., 2 miles, 5 miles, etc.) that can be automatically determined by alert component 210 or that can be indicated by person 602, for example, via secondary instructions provided to task generation model 112. Alert 128 can also employ GPS data from the smartphone, smartwatch, another device or vehicle (e.g., if person 602 is driving a car and has a smartphone connected to the car) of person 602 to determine the exact distance of person 602 from grocery store 604 at any given time and notify person 602 of the same.

As stated in one or more embodiments, alert 128 can comprise any suitable alert based on the tasks generated by task generation model 112.

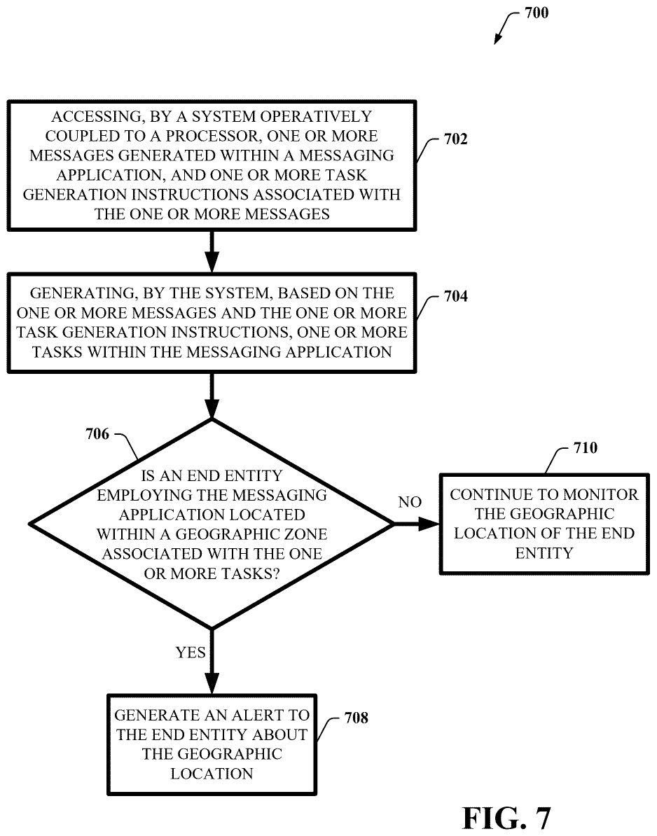

FIG. 7 illustrates a flow diagram of an example, non-limiting method 700 that can convert messages generated within a messaging application into tasks within the messaging application and that can generate alerts based on the tasks, in accordance with one or more embodiments described herein. Repetitive description of like elements and/or processes employed in respective embodiments is omitted for sake of brevity.

At 702, non-limiting method 700 can comprise accessing (e.g., by data access component 202), by a system operatively coupled to a processor, one or more messages generated within a messaging application, and one or more task generation instructions associated with the one or more messages.

At 704, non-limiting method 700 can comprise generating (e.g., by task generation component 206), by the system, based on the one or more messages and the one or more task generation instructions, one or more tasks within the messaging application.

At 706, non-limiting method 700 can comprise determining (e.g., by alert component 210), by the system, whether an end entity (e.g., hardware, software, machine, AI, neural network and/or user) employing the messaging application (e.g., to generate the one or more messages and the one or more task generation instructions) is located within a geographic zone associated with the one or more tasks.

If yes, then at 708, non-limiting method 700 can comprise generating (e.g., by alert component 210), by the system, an alert to the end entity about the geographic location. For example, alert component 210 can generate alert 128 notifying the end entity that the end entity is within a geographic zone of a grocery store, a post office, etc., in accordance with the embodiments of the present disclosure.

If not, then at 710, non-limiting method 700 can comprise continuing (e.g., by alert component 210), by the system, to monitor the geographic location of the end entity (e.g., via a GPS module within the end entity's smartphone or vehicle).

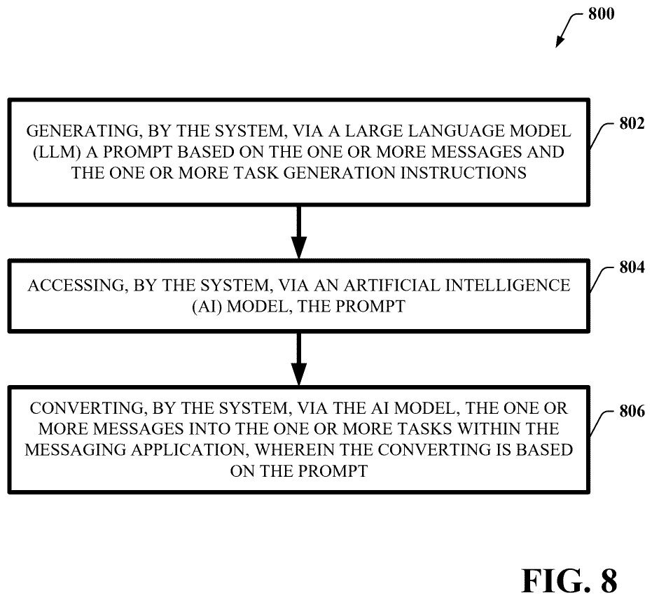

FIG. 8 illustrates a flow diagram of an example, non-limiting method 800 that can convert messages generated within a messaging application into tasks within the messaging application, in accordance with one or more embodiments described herein. Repetitive description of like elements and/or processes employed in respective embodiments is omitted for sake of brevity.

With continued reference to non-limiting method 700, non-limiting method 800 illustrates additional steps that can be employed to generate, at 704 of non-limiting method 700, the one or more tasks within the messaging application.

Accordingly, at 802, non-limiting method 800 can comprise generating, by the system, via an LLM (e.g., by prompt generation component 204), a prompt based on the one or more messages and the one or more task generation instructions.

At 804, non-limiting method 800 can comprise accessing, by the system, via an AI model (e.g., task generation component 206), the prompt.

At 806, non-limiting method 800 can comprise converting, by the system, via the AI model (e.g., task generation component 206), the one or more messages into the one or more tasks within the messaging application, wherein the converting is based on the prompt.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 9 and the following discussion are intended to provide a brief, general description of a suitable computing environment 900 in which the various embodiments described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structures that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and a drive 920, e.g., such as a solid state drive, an optical disk drive, which can read or write from a disk 922, such as a CD-ROM disc, a DVD, a BD, etc. Alternatively, where a solid state drive is involved, disk 922 would not be included, unless separate. While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and drive 920 can be connected to the system bus 908 by an HDD interface 924, an external storage interface 926 and a drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the OS kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above, such as but not limited to a network virtual machine providing one or more aspects of storage or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

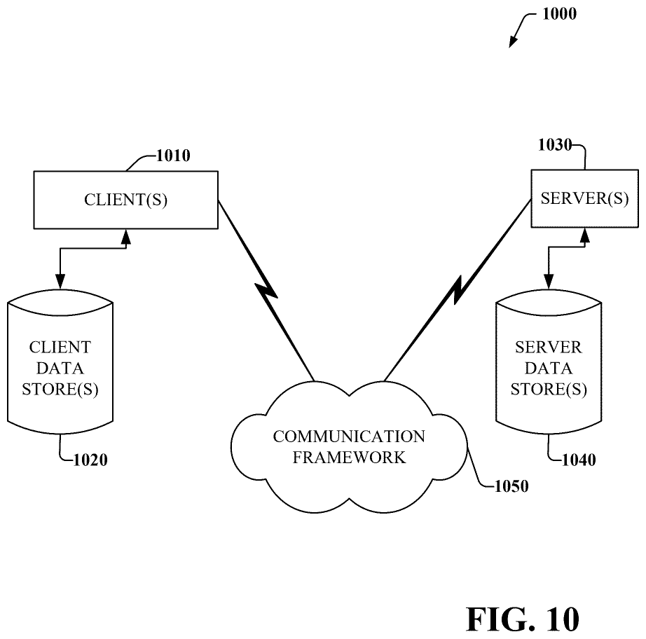

FIG. 10 is a schematic block diagram of a sample computing environment 1000 with which the disclosed subject matter can interact. The sample computing environment 1000 includes one or more client(s) 1010. The client(s) 1010 can be hardware or software (e.g., threads, processes, computing devices). The sample computing environment 1000 also includes one or more server(s) 1030. The server(s) 1030 can also be hardware or software (e.g., threads, processes, computing devices). The servers 1030 can house threads to perform transformations by employing one or more embodiments as described herein, for example. One possible communication between a client 1010 and a server 1030 can be in the form of a data packet adapted to be transmitted between two or more computer processes. The sample computing environment 1000 includes a communication framework 1050 that can be employed to facilitate communications between the client(s) 1010 and the server(s) 1030. The client(s) 1010 are operably connected to one or more client data store(s) 1020 that can be employed to store information local to the client(s) 1010. Similarly, the server(s) 1030 are operably connected to one or more server data store(s) 1040 that can be employed to store information local to the servers 1030.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-core processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor that executes the computer-executable components stored in the memory, wherein the computer-executable components comprise:
a data access component that accesses one or more messages generated within a messaging application, and one or more task generation instructions associated with the one or more messages; and
a task generation component that generates, based on the one or more messages and the one or more task generation instructions, one or more tasks within the messaging application.

2. The system of claim 1, wherein the task generation component is an artificial intelligence (AI) model, and wherein generating the one or more tasks comprises:
generating, by a prompt generation component, a prompt based on the one or more messages and the one or more task generation instructions, wherein the prompt generation component can be a large language model (LLM);
accessing, by the task generation component, the prompt; and
converting, by the task generation component, based on the prompt, the one or more messages into the one or more tasks within the messaging application.

3. The system of claim 1, wherein respective tasks of the one or more tasks correspond to respective actions that are executable by an end user of the messaging application, and wherein the respective tasks are generated within the messaging application with respective checkboxes that are employable by the end user to indicate respective completion statuses of the respective actions.

4. The system of claim 3, wherein the task generation component further generates secondary data to assist the end user to execute the respective actions, wherein the secondary data comprises geographic location information associated with the respective actions.

5. The system of claim 4, further comprising:
an alert component that generates, based on the geographic location information, an alert to the end user, wherein the alert informs the end user that the end user is within a geographic zone associated with the respective actions.

6. The system of claim 1, further comprising:
a task storage component that stores the one or more tasks as stored tasks in a storage.

7. The system of claim 6, further comprising:
a training component that employs the stored tasks to periodically train the task generation component, wherein training the task generation component comprises:
generating, by the training component, based on the stored tasks, a training dataset; and
training, by the training component, the task generation component to generate new tasks with increased accuracy.

8. The system of claim 1, wherein the one or more task generation instructions comprise at least one type of instructions selected from a group consisting of verbal instructions and non-verbal instructions.

9. The system of claim 1, wherein the one or more messages and the one or more task generation instructions are accessed via cloud-based communication.

10. The system of claim 1, wherein the one or more tasks are generated via cloud-based quantum computing.

11. A computer-implemented method, comprising:
accessing, by a system operatively coupled to a processor, one or more messages generated within a messaging application, and one or more task generation instructions associated with the one or more messages; and
generating, by the system, based on the one or more messages and the one or more task generation instructions, one or more tasks within the messaging application.

12. The computer-implemented method of claim 11, wherein the one or more tasks are generated via an AI model, and wherein the generating comprises:
generating, by the system, via an LLM, a prompt based on the one or more messages and the one or more task generation instructions;
accessing, by the system, via the AI model, the prompt; and
converting, by the system, via the AI model, the one or more messages into the one or more tasks within the messaging application, wherein the converting is based on the prompt.

13. The computer-implemented method of claim 11, wherein respective tasks of the one or more tasks correspond to respective actions that are executable by an end user of the messaging application, and wherein the computer-implemented method further comprises:
generating, by the system, the respective tasks within the messaging application with respective checkboxes that are employable by the end user to indicate respective completion statuses of the respective actions.

14. The computer-implemented method of claim 13, further comprising:
generating, by the system, secondary data to assist the end user to execute the respective actions, wherein the secondary data comprises geographic location information associated with the respective actions.

15. The computer-implemented method of claim 14, further comprising:
generating, by the system, based on the geographic location information, an alert to the end user, wherein the alert informs the end user that the end user is within a geographic zone associated with the respective actions.

16. The computer-implemented method of claim 11, wherein the one or more task generation instructions comprise at least one type of instructions selected from a group consisting of verbal instructions and non-verbal instructions.

17. The computer-implemented method of claim 11, further comprising:
the accessing, by the system, the one or more messages and the one or more task generation instructions via cloud-based communication.

18. The computer-implemented method of claim 11, further comprising:
the generating, by the system, the one or more tasks via cloud-based quantum computing.

19. A computer program product comprising a computer readable storage medium having program instructions embodied therewith, the program instructions executable by a processor to cause the processor to:
access, by the processor, one or more messages generated within a messaging application, and one or more task generation instructions associated with the one or more messages; and
generate, by the processor, based on the one or more messages and the one or more task generation instructions, one or more tasks within the messaging application.

20. The computer program product of claim 19, wherein the one or more tasks are generated via an AI model, and wherein the program instructions are further executable by the processor to cause the processor to:
generate, by the processor, via an LLM, a prompt based on the one or more messages and the one or more task generation instructions;
access, by the processor, via the AI model, the prompt; and
convert, by the processor, via the AI model, the one or more messages into the one or more tasks within the messaging application, wherein the converting is based on the prompt.
